(19) United States
(12) Patent Application Publication
(10) Pub. No.: US 2001/0026428 A1
(43) Pub. Date: Oct. 4, 2001

(54) Relay with overcurrent protection

(76) Inventors: Angelo Polese, Falkensee (DE); Ernst-Ulrich Berndt, Berlin (DE)

Correspondence Address: Barley, Snyder, Senft & Cohen, LLC, 126 East King Street, Lancaster, PA, 17602-2893, US

(21) Appl. No.: 09/747,205

(22) Filed: Dec. 22, 2000

(30) Foreign Application Priority Data
Dec. 28, 1999 (DE) 199 63 504.8

(51) Int. Cl. H02H 3/08

(52) U.S. Cl. 361/93.1

(57) ABSTRACT

A winding is provided in the load current circuit and arranged such that a current flowing in the load circuit induces a voltage in the excitation circuit which is superimposed thereon. An electronic unit evaluates this signal and the relay is turned off in case a load current threshold is exceeded.

### FIELD OF THE INVENTION

The invention relates to a relay with overcurrent protection having an excitation circuit and a load current circuit, the load current circuit being coupled with a measuring system that deactivates the excitation circuit when a predetermined load current threshold is exceeded.

### BACKGROUND

A known example of limiting the load current is shown in German utility model 29720249.9. Here the relay has a pluggable fuse connected in series with the load which interrupts the load circuit in case of excess current.

The German patent specification DE 19636932 C-1 discloses a relay with overload protection, in which overcurrent protection is realized by means of a PTC thermistor connected in series with the load. In an overcurrent condition this PTC thermistor abruptly changes to the high-impedance state to interrupt the load circuit.

Another circuit arrangement with overload protection for a relay is shown in European patent application 0829939 A-2. This application also makes use of a PTC thermistor. Here, the PTC thermistor is connected in series in the excitation current circuit of a relay and is positioned to be heated by a heating section in the load current circuit of the relay. Upon occurrence of overload, the PTC thermistor is heated above its transition temperature, changes to the high-impedance state and causes the relay to drop so that the load current circuit is interrupted.

European patent specification 0231793 B-1 shows an electromagnetic relay in which a current supply element of the load current circuit has at least one winding wound around part of the excitation flow circuit. Additional excitation is therefore created in the excitation circuit by the additional winding or coil. In this manner, relay pick up is ensured in cases where a single voltage source feeds both the excitation and load circuits.

The first three of the above-mentioned documents each show relays with overcurrent protection. However, they share the disadvantage that that they each require additional components in the load circuit, such as fuses, heating elements or thermistors. In addition using a fuse involves the disadvantage that it must be replaced after an overcurrent occurs.

Document EP 0231793 B-1 discloses load current feedback to the excitation circuit by means of at least one additional winding of the load circuit around part of the excitation flow circuit. This does not protect the relay against excess current, but is to ensure safe response of the relay when the excitation winding and load current circuit are fed from the same voltage source and a high switching-on current of the load circuit results in breakdown of the voltage on the excitation winding. This arrangement is undesirable because it lacks electrical isolation between the load circuit and excitation circuit.

It is therefore an object of the present invention to provide a relay having overcurrent protection without requiring additional components in the load circuit. In addition, electrical isolation is provided between the excitation current circuit and the load current circuit.

### SUMMARY

According to the invention, these and other objects are achieved by a relay having an electromagnet device with an excitation winding, and a switching contact in a load circuit which is adapted to be operated by the electromagnet device. At least one conductor section in the load circuit is arranged such that a load current flowing upon response of the relay induces a voltage signal in the excitation winding. An electronic unit evaluates this voltage signal and acts upon the excitation current circuit.

### BRIEF DESCRIPTION OF THE DRAWINGS

The invention will be described with reference to the accompanying figures of which:

FIG. 1 shows a block diagram of the fundamental circuit arrangement of a relay according to the invention,

FIG. 2 shows an oscillogram of the excitation current along with an AC component induced by the load current,

FIG. 3 shows a relay according to the invention having a coupling loop, and

FIG. 4 shows a circuit diagram of a relay with overcurrent protection.

### DETAILED DESCRIPTION OF THE PREFERRED EMBODIMENT

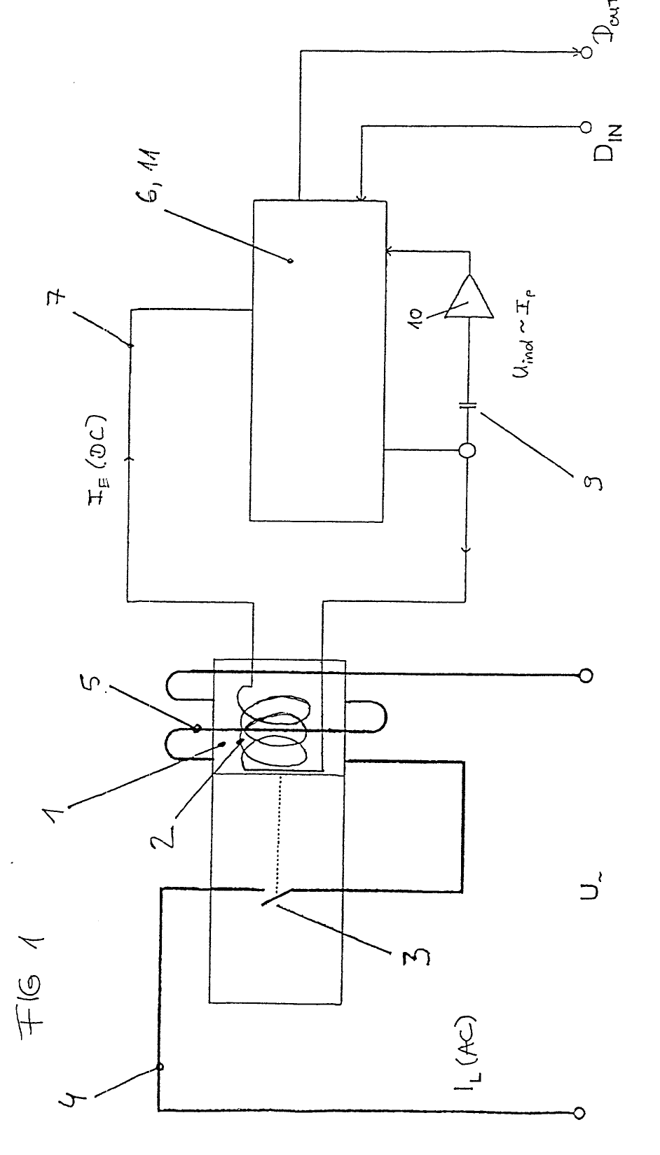

FIG. 1 shows a relay according to the invention, comprising an electromagnet device 1 having an excitation coil or winding 2. This electromagnet device 1 operates a switching contact 3 disposed in a load circuit. The load circuit 4 is an alternating current (AC) circuit. On the excitation side of the relay, the excitation winding 2 has an excitation circuit 7 connected thereto. If a direct current (DC) excitation current flows in excitation current circuit 7, the electromagnet device 1 actuates switching contact 3 to allow an AC load current to flow in load circuit 4. The winding 5 in the load circuit is positioned such that the load current induces a voltage in the excitation winding which is superimposed on the DC excitation current. This induced voltage signal is dependent on and corresponds to the load current amplitude, phase position and frequency. The induced AC component is coupled to the excitation current circuit by a capacitor 9. If necessary, this signal is amplified by an amplifier 10 before it is processed in a microprocessor 11. In case an adjustable load current threshold is exceeded, the relay is turned off or deactivated electronically. The deactivation threshold can be adjusted, for example, via a controller circuit and a bus system. It is also possible to realize this deactivation threshold by means of a circuit of analog external components.

In FIG. 1, the design of the winding 5 in load circuit 4, is illustrated by way of example as an additional winding around relay coil 2. However, coupling of the load circuit into the excitation current circuit is alternatively achieved by way of a coupling loop that may be attached close to the armature of the relay. With an appropriate construction, it is even possible that the current flow alone through one or more load terminals may be sufficient for feedback of the load current into the excitation circuit.

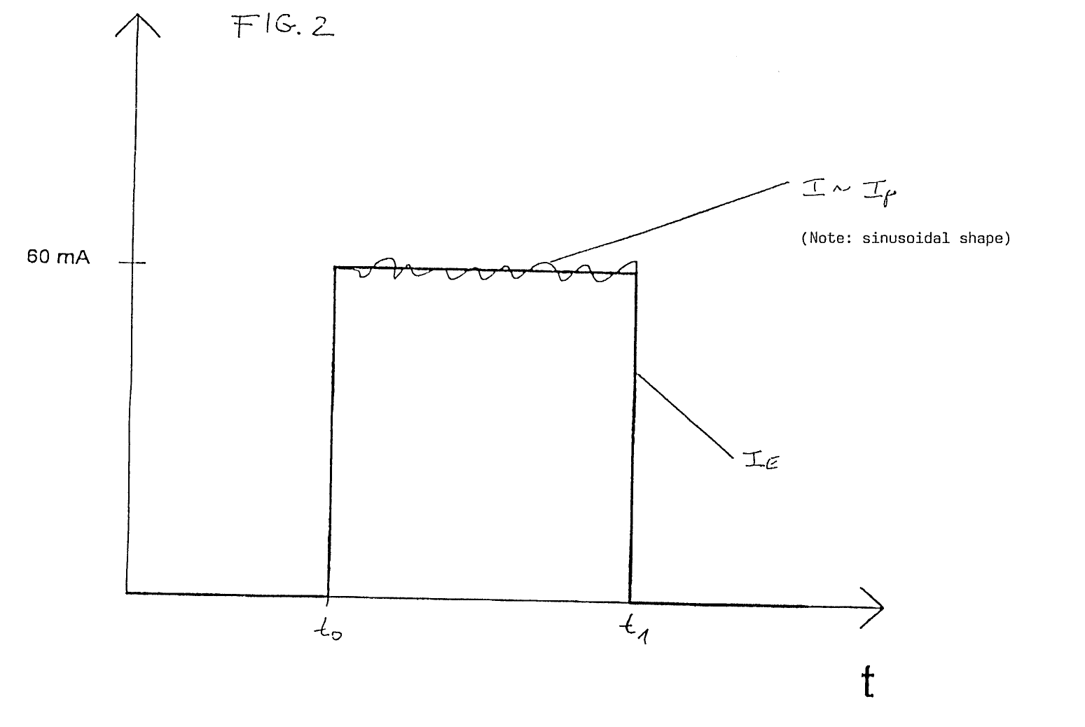

FIG. 2 is a ocillogram graph of the excitation current versus time. This current is composed of an excitation current which is DC and an AC component that is induced from the load circuit via the excitation winding. The points of time t0 and t1 indicate the turn-on time and the turn-off time of the relay, respectively.

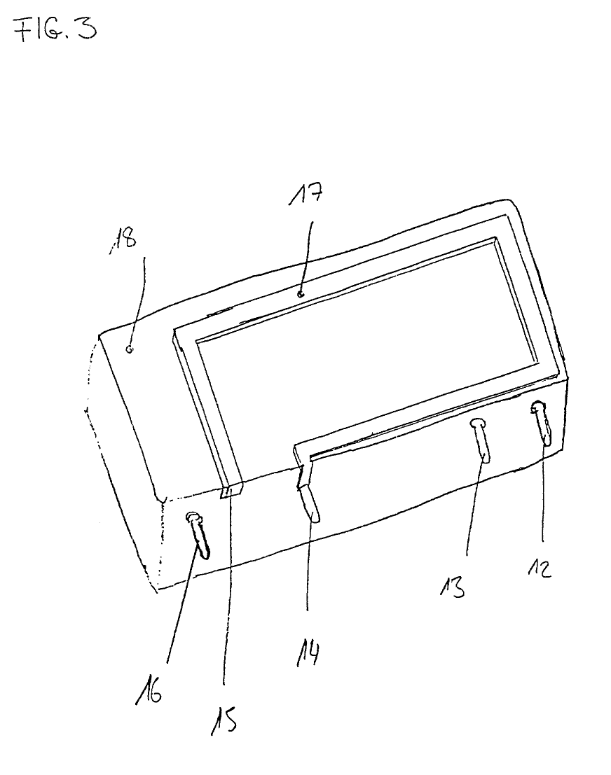

FIG. 3 shows an embodiment of the present invention in which no additional winding is provided around the excitation winding 2 of the electromagnet device 1, but instead a coupling loop 17 is disposed on the outside of the relay housing, in series with the load circuit. This arrangement, illustrated here by way of example on a conventional relay is sufficient for coupling an AC signal from load current circuit 4 into the excitation current circuit 7. The evaluation electronics required for further processing of this induced voltage signal are not shown in FIG. 3.

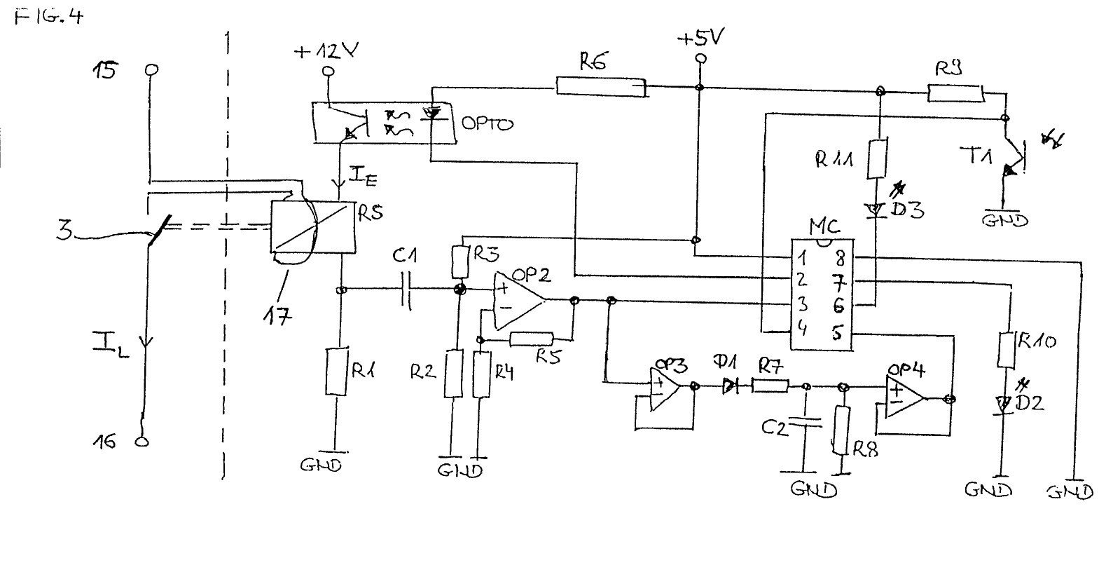

FIG. 4 shows a circuit diagram for a relay with overcurrent protection according to the present invention. A coupling loop 17 extends around relay RS as illustrated in FIG. 3. The relay RS acts on a load contact 3 arranged in series with the coupling loop 17 in the load circuit. The load to be switched is connected to load contacts 15, 16. When relay contact 3 closes, the load current IL flows through the coupling loop 17. Current is supplied to the relay on the excitation side by an opto-coupler in series with a resistor R1, preferrably 100 ohms. The opto-coupler is controlled by a microcontroller MC. At resistor R1, there is a voltage drop, with the AC component thereof being proportional to load current IL. Consequently, the excitation winding 2 of relay RS acts as a sensor coil for the load current. Via capacitor C1, preferrably 100 nanofarads, the AC component is coupled from the excitation current circuit to operational amplifier OP2. By means of resistors R3, preferably 50 kiloohms, and R1, preferably 1 kiloohm, a slight bias is produced. Negative feedback is provided via resistors R4, preferrably 10 kilohms, and R5, preferably 100 kiloohms. After approximately a 10-fold amplification of the induced AC signal in operational amplifier OP2, this signal is fed to pin 3 which is an A/D converter input of a microcontroller MC.

By means of operational amplifiers OP3 and OP4 as well as diode D1 and capacitor C2, optimum average value formation of the induced voltage signal is realized. Operational amplifiers OP3 and OP4 each serve for buffering the signal. By means of diode D1, the signal is rectified, and a smoothed voltage is available at C2. In addition thereto, a series resistor R7, preferably 100 ohms, as well a resistor R8, preferably 50 kiloohms, are required. The signal obtained with this additional analog smoothing circuit is supplied to pin 8 of microcontroller MC. This pin also constitutes an. A/D converter input of the microcontroller. In case of a load current frequency of 50 H,z, the microcontroller, with a typical conversion time of 40 μs, can carry out up to 500 measurements per period for peak value recognition of the load current, or can evaluate the average value produced in an analog manner. In terms of software, the microcontroller can be used for realizing the following functions, for example, smoothing, peak value calculation, calculation of a trend, interference suppression, fast Fourier transform (FFT), or limit value monitoring.

If the microcontroller MC e.g. measures a current that is above a defined limit value, the relay is deactivated to protect it from overcurrent. Automatic reactivation is not provided for on the hardware side. However, by way of resistor R9 and infrared receiver T1, the microcontroller has an infrared input and an interface with a control computer, and via resistor RIO and infrared diode D2, it has an infrared output interface. This allows the use of a computer to set limit values and to pass current data on to the computer. Pin 6 of the microcontroller has an additional light-emitting diode connected thereto through which an interference signal can be issued. The optical interface realized by receiver T1 and transmitter D2 can easily be connected, also via optical transmitting and receiving elements, to a conventional RS 232 interface of a personal computer (PC).

For reducing wear on the relay load contacts, it is easily possible according to the invention to detect the current zero crossing of load current IL by means of the microcontroller and to advantageously turn off the load current at this current zero crossing.

In an advantageous embodiment of the invention, the relay is constructed so that the electronic unit is disposed on the outside of a relay cap. Conductive tracks on the relay cap can be established, for example, by forming the relay cap in the so-called MID (molded interconnect device) technique or by electroplating and structuring utilizing a laser or by etching. Additionally, the electronic unit not may be arranging external to the relay, for example on the circuit board carrying the relay.

An advantage of the present invention is that the load circuit does not require additional components for protecting the relay against overload or short circuiting. Regarding the constructional design of the relay, it is simply necessary to take care that the geometrical arrangement of the load current terminals or of the load circuit, respectively, is such that the field of the load current can be coupled into the excitation coil. Another advantage of the relay according to the invention resides in that electrical isolation of excitation current circuit and load current circuit is maintained.

In an advantageous embodiment of the invention, coupling of the load current into the excitation current circuit is enhanced in that the load circuit contains a coupling loop attached, for example, close to the armature of the relay.

In a further advantageous embodiment, the relay coil has an additional winding placed around it which is connected into the load circuit and provides increased coupling of the load current into the excitation circuit.

Finally, the evaluation of the voltage signal caused by the load circuit and induced in the excitation circuit, allows switching of the relay exactly at the time of zero crossing of the current wave, thus minimizing contact erosion on the load contacts.

What is claimed is:

1. A relay comprising:
an electromagnet device having an excitation winding,
a switching contact in a load circuit, which is adapted to be operated by said electromagnet device,
at least one conductor section in the load circuit which, with respect to the excitation winding, is arranged such that a load current flowing upon response of the relay induces a voltage signal in the excitation winding, and,
an electronic unit evaluating the induced voltage signal and acting upon the excitation current circuit.

2. The relay of claim 1 wherein the conductor section is an additional winding around the excitation winding.

3. The relay of claim 1 wherein the conductor section is a coupling loop.

4. The relay of claim 1 wherein the electronic unit is arranged within a housing of the relay.

5. The relay of claim 1 wherein the electronic unit is accommodated in a module adapted to be pluggably attached to the housing.

6. The relay of claim 1 wherein the electronic unit is arranged on the outside of a cap of the relay.

7. The relay of claim 6 wherein the cap of the relay is produced by molding in an MID (molded interconnect technique) method and conductive tracks are disposed on the cap.

8. The relay of claim 6 wherein the cap of the relay is at least partly electroplated and conductive tracks are formed by laser structuring or etching.

9. The relay of claim 1 wherein the electronic unit electronically interrupts the excitation current circuit of the relay when an adjustable load current threshold is exceeded.

10. The relay of claim 9 wherein the electronic unit turns off the load current at the current zero crossing thereof.

11. The relay of claim 1 wherein the electronic unit comprises a microprocessor processing the induced voltage signal, the microprocessor being decoupled to the excitation winding circuit by a capacitor

12. The relay of claim 11 further comprising an amplifier coupled to the capacitor.

13. The relay of claim 12 wherein the electronic unit is coupled via an optical interface to the excitation winding circuit and is adapted to act on the same.
